(19) United States
(12) Patent Application Publication
(10) Pub. No.: US 2025/0230064 A1
(43) Pub. Date: Jul. 17, 2025

(54) Portable Water Recovery System

(71) Applicant: Emanuel Voyiaziakis, Long Beach, NY (US)

(72) Inventor: Emanuel Voyiaziakis, Long Beach, NY (US)

(21) Appl. No.: 18/412,901

(22) Filed: Jan. 15, 2024

(51) Int. Cl. C02F 1/14; B01D 1/00; B01D 5/00; C02F 1/04; C02F 1/68; C02F 103/08

(52) U.S. Cl. CPC C02F 1/14; B01D 1/0035; B01D 5/0066; B01D 5/009; C02F 1/043; C02F 1/685; C02F 2103/08; C02F 2201/004

(57) ABSTRACT

A potable water recovery system that can purify all manner of salt water or other contaminated water sources and be highly portable and inexpensive to manufacture and maintain. In some embodiments, the portable water recovery system can be disassembled for storage or transport. Additionally, the dissembled portable water recovery system can be easily packed in a small volume and transported in a backpack.

### TECHNICAL FIELD

The present invention relates to a device for recovering potable water condensate from potentially contaminated water sources. Certain embodiments of the present invention include methods to increase the yield of potable water. Additionally, certain embodiments of the present invention are designed to be, when disassembled, packed in a small volume, lightweight and highly portable. For instance, certain embodiments of the present invention are designed for use by a backpacker, explorer, remote traveler, RV user, or maritime craft user or even routine home use under situations of duress such as disrupted water supply, naturally occurring vs. other water shortages, natural disasters, or even war-time environments.

Embodiments of the present invention provide a device suitable for marine applications, notably at sea or on rivers, lakes or ponds or collections of brackish and/or contaminated or even poisoned water sources. Other embodiments of the present invention are suitable for land-based applications, including remote and/or water-scarce settings or off-the-grid type applications.

A process of the present invention collects a potable water condensate from water vapor produced by solar radiation (energy) or other energy, or a combination thereof, to create and enhance the yield of drinking water condensate.

Marine embodiments of the present invention typically desalinate salt-water using solar energy. Inland embodiments of the present invention may be used to produce potable water from contaminated water (typically water laden with mineral salts). Inland embodiments of the present invention may also be used to collect a potable condensate from moisture in the ground and/or from vegetation.

### BACKGROUND ART

To prepare for marine and marine-aviations emergencies, those skilled in the art have made mobile inflatable seawater desalinization devices. For example, GB 832,123 describes an inflatable PVC ring which acts as a floating base structure and a separate conical transparent PVC-type sheet that is placed over this floating base. This conical sheet serves as surface for condensing water vapor. In this design, the condensate is collected between the outside of the ring and inside of the cone. However, the cone sheet is conformationally and/or directionally unstable. The cone is maintained in its required shape by means of supporting rods.

A disadvantage of such inflatable designs is that the sheets are easily damaged or perforated. Moreover, these structures include rods that require appropriate assembly to avoid malfunctioning. Furthermore, the manufacture of the individual parts of these devices is comparably expensive. Additionally, these devices are difficult to clean due to the flexibility of their sheets. Another disadvantage of these devices is that the sheets are exposed to mechanical loads that may exceed their functional limits. These devices are also sensitive to outside weather conditions such as wind and rain and wave forces. Finally, the discharge of the collected condensate is inconvenient. Typically, the condensate must be poured out via the underside of the device which may cause some of the condensate to be lost.

U.S. Pat. No. 3,415,719 discloses a foldable device for the recovery of condensed water that uses solar energy. The described embodiment has an inflatable transparent plastic body to which a collector receptacle permeable to water vapor is provided as a bottom element for collecting the condensate. This device is to be placed on a water body. The embodiment described in this patent occupies a significant volume. Moreover, the description does not state that the described embodiment can be readily disassembled. Thus, this device cannot readily be used in mobile land-based applications, e.g., by a backpacker. Moreover, the device is completely dysfunctional when punctured, should this occur for any reason.

U.S. Pat. No. 7,008,515 describes another device for recovery of condensed water. The device described in this reference has a conical bonnet whose inferior end results in an inward and upward fold to form a collecting channel. The described device has a dual-use bottom plate. The bottom plate can act as an evaporating surface. Additionally, the bottom plate may include a buoyancy ring enhancing floating applications.

Furthermore, the device described by U.S. Pat. No. 7,008,515 requires an expensive manufacturing process. For instance, the inflatable floating ring, and the sensitive configuration of the evaporating plate make the manufacture of this device expensive. Moreover, as assembled, this device is bulky.

U.S. Pat. No. 7,534,327 describes a floating or land-based device along with a method for making the described device. The described production method uses a deep-drawing technique thereby rendering the cost of production expensive.

Notwithstanding the developments to date, there remains a need in the art for a low-cost, lightweight, ultra-compact (notably when disassembled) water recovery system. Moreover, there is a need for such a system that can be used by any end-user needing clean water. Specifically, there remains a need for a water recovery system that can be remotely situated without potable water or energy source. In particular, an ordinary backpacker, RV user, offshore marine enthusiast, etc. may need a highly portable potable water recovery system.

### SUMMARY OF THE INVENTION

The present invention provides a lightweight and compact water recovery system suitable for use by, for example, a backpacker, mariner, home-dweller in an emergency situation (e.g., flooding vs. freshwater deficits) or emergency services provider. The water recovery system of the present invention, in one embodiment, is readily disassembled into small, symmetrical stacking and nesting lightweight parts, and the portions of which can be stored in a small volume for ease of portability and/or storage and rapid deployment. Additionally, in another novel embodiment of the present invention, the water recovery system of the present invention importantly can be expanded to variably increase its condensing surface commensurate with need.

In further embodiments of the present invention, a passive solar energy adaptation can be added. For instance, a contaminant source-water tray that readily absorbs solar radiation that also is very absorptive of heat can be placed under, preferably also attached to the water recovery system of the present invention (to prevent spillage of non-potable source-water). In another embodiment, a lens such as a Fresnel lens can be attached to the water recovery system of the present invention to focus the incoming solar light on the contaminated source water, further driving the energy and temperature gradient that drives the condensation process.

In a further embodiment of the water recovery system of the present invention, the condensing surface may be modified to permit a cooling material, for instance, snow, to be placed on a grooved-exterior surface of the water recovery system to improve condensation and yield of potable water.

In a still further embodiment of the present invention, the water recovery system may have a plurality of perforations to increase the cooling on the condensing surface of the water recovery system and thereby improve condensation and yield of potable water.

In a still further embodiment of the present invention, the water recovery system may have internally directed and detachable magnetic fins to increase the internal condensing surface of the system and allow a wiping motion of the internal surface to “reset” the inner condensing surface of the system and thereby improve condensation and yield of potable water. These fins are envisioned as non-permanent additions that are removable and cleanable, minimizing manufacturing variations in the inner conformation of the collecting surface. They can be made of metal to add ions or made of plastic with an embedded magnet (with capturing magnet on external surface of the system). Alternatively, they can be removed as wall-size, i.e., middle portion height (h), is increased, or added back as temperature gradient within the device increases, and therefore condensate yield, increases (see FIG. 2 vs. 8 vs. 9).

In a still further embodiment of the present invention, the water recovery system may have enhancements to allow external portable or stationary energy sources, e.g, solar panels, batteries, etc., to further heat the contaminated source-water tray and thereby enhance the energy gradient and enhance condensation and yield of potable water.

For instance, the non-potable water source may be poured into a tray that has a resistance coil on the bottom that can heat this tray as desired.

Preferred features improving embodiments of the invention in an expedient manner can be derived from additional disclosure provided herein below. Use of symmetry and redundancy in component parts of said device allows for reduction in manufacturing capital outlay and ongoing manufacturing costs, while enhancing stackability and nesting and thereby portability and storage.

Due to the inventive configurations of the device, definite advantages are achieved in terms of manufacture, use and utilization. Typically, the water recovery system will have a conical, frustoconical, or pyramidal shape. Generally, the structure of the water recovery system of the present invention is made of a strong but flexible material such as PET, PE, PP or PC. In this manner, a sufficient mechanical strength is achieved to resist damage that could be caused by pointed or blunt objects or other forces, as well as routine wear and tear or transportation of the device. Moreover, certain embodiments of the water recovery system of the present invention permit minimal, but desirable slight deformation under the influence of wind and/or other elements. Such deformations are believed to facilitate the collection of condensate: this deformation serves to disrupt droplets on the inner condensing surface to facilitate gravity-generated collection inferiorly towards and into the collecting channel. As a result, such deformations are believed to “reset” the condensing surface of the device for ongoing collection of condensate, i.e, improving yield. The functional conformational integrity of the water recovery system is therefore not overly impaired by exterior weather conditions such as rain, wind and the like. Rather, such transient deformations can facilitate additional collection of condensate.

In one embodiment of the water recovery system of the present invention, the system comprises, sitting atop the contaminant source tray or water or ground, an inner cone with a central aperture at its apex. This inner cone, at its inferior peripheral edges is, in contact with, or connected to, the interior edge of a cylindrical structure—side wall—at the base of the side wall. Situated above the (horizontal plane of the) inner cone, and immediately atop the cylindrical structure is an upper cone. The upper cone also has a central aperture at its apex. It is preferred that said side wall is substantially perpendicular to the surface that the water recovery system rests upon.

The 3-dimensional geometry of the collecting channel at the intersection of said inner cone and said side wall provides buoyancy to the device.

In yet a further embodiment of the present invention, non-potable water can be sourced, added or pumped into the evaporation source tray. Desirably, the addition of non-potable water to the source tray is at a rate approximating the evaporation of the water vapor from the evaporation tray.

In some embodiments, such as when used in a marine environment, a floating body or buoyancy ring or even marine safety floatation device can be added to stabilize the device. Alternatively, the device itself or an adjacent “ring” of devices can be used to stabilize an adjacent device.

In an embodiment for use on land, a deep (contaminant-water) source plate may be used so that the device can be left unattended for an extended period, e.g., as on a rooftop.

In some embodiments of the water recovery system of the present invention a side wall has a port into which a unidirectional valve may be added.

Embodiments of the present invention can be made from symmetrical parts that can be readily assembled and disassembled. In part for this reason, it is believed that the water recovery system of the present invention can be manufactured inexpensively.

Additionally, any damage to the structure (e.g., cracks, burns, wear and tear, animal bites, etc.) is easily rectified by promptly swapping out the damaged section.

Furthermore, the ability of embodiments of the present invention to be readily disassembled permits the user to readily clean the device and remove any mold, algae, dust or other contaminant(s) from the device enhancing purity and safety of the condensate.

In some embodiments of the water recovery system of the present invention, the water recovery system further includes a closing feature. This closing features is positioned on top of the upper edge of the upper cone. It is further preferred that this closing feature is secured to the upper cone of the water recovery system of the present invention.

It is further preferred that at the apex of the closing feature there is a short upwardly projecting cylinder. It is still further preferred that said short upwardly projection cylinder has threads that mate with a conventional water bottle cap.

Drinking or decanting from the screw plug opening at the top of the device also serves to wash and remove condensate from the inner surface of the cone between the cap and condensation tray, “resetting” the device for further condensation collection.

An alternative use of the water recovery system of the present invention is that it may be used as a rain collection device. Before using the water recovery system as a rain collector, the portions of the device previously exposed to non-potable water should be cleaned using conventional methods. Once cleaned, to provide for the stability of an inverted water recovery system of the present invention, the device is placed upside down in a recess in earth or sand or rocks for stability and may be left unattended. Said configuration would require no collecting plate in place, so that water now collects into the top of the device, filling upwards towards the bottom of the device.

The collecting chamber of the water recovery system of the present invention is generally formed by the intersection, or connection, of the side wall and the inner cone. The condensate dripping (due to downward force of gravity) off the inner surface of upper cone as well as the interior side of the side wall will collect in the collecting chamber. Until the collecting chamber is filled, the condensate flows into the collecting chamber, and not back into the contaminated water source tray.

In an alternative embodiment of the present invention, a short hollow cylinder is mounted on the apex of the lower most inner cone of the water recovery system of the present invention. This inner cone with an upwardly projecting cylinder serves as protection in a hostile marine environment from the undesirable penetration of (salt water or contaminant water) waves on which the device is floating, i.e., preventing contaminated water from entering the collecting channel necessitating complete restart or reset of the condensation process.

In a still further embodiment of the water recovery system of the present invention the upper edge of the inner cone can be configured to have a further variant wall projecting downwardly from the interior upper edge of the inner cone. This downwardly projecting wall is to protect the collecting channel from wave motion forcing unwanted entrance of contaminated water into the collecting channel. It is anticipated that this downwardly projecting wall will form an angle with the inner cone of about 45 to about 120 degrees.

In yet a further embodiment of water recovery system of the present invention the uppermost edge of the inner collecting wall can be projected upwards further into the space of the device by a detachable tube having an inner diameter equal in diameter to the innermost opening of the lower cone. Preferably, the lower cone has a short cylindrical upward projecting extension. It is further preferred that the exterior of this short cylindrical upward projection extension has threads. A cylindrical tube having a matching thread on its exterior can be connected to matching threads on the lower cone. In cases of large condensate yields, this added protective structure added to the top of the inner collecting wall can protect against partial submersion of the device when employed in a marine environment and/or when disruptive movements of the device are envisioned (e.g., waves or wind-storms).

A further preferred embodiment of an upward projecting cylindrical tube has a conventional one-way floating ball-in-valve such as might be found in a snorkel or known equivalent structures that prevent waves of water from entering a floating device. Nonetheless, when the water is not raising the cutoff mechanism, the system permits water vapor to flow upwards into the device.

It is further preferred that the material used to make the external, i.e., not the condensing internal surfaces of the water recovery system of the present invention, be a conventional non-fogging material (e.g., anti-fog polycarbonate coated on one side to offer long term anti-fog properties or alternatively spray-on anti-fogging materials that are inexpensive and readily commercially available), or that such surfaces have a non-fogging potential to avoid minimizing of direct sunlight striking the contaminant source plate via the upper cone and/or middle section.

Similarly, it is also preferred that the material used to make the inner and outer surfaces of the water recovery system of the present invention is scratch resistant to avoid minimizing of direct sunlight striking the contaminant source plate via the upper cone and/or middle section.

The upper cone can optionally have micro-pores that allow small amounts of vapor to pass through the device and collect on outer surfaces that will then evaporate and serve to cool the external surface of the device. Alternatively, and also based on pore-sizing, one can envision slight pressure building inside the water recovery device via the addition of heat to the system, and such pressure would serve to extrude small amounts of vapor through such pores then resulting in a cooling effect proximal to the device (as explained by the ideal gas law). This, in turn, would further drive the temperature gradient driving condensation (see FIG. 13).

In an alternative embodiment of the water recovery system of the present invention, one or more structures having an aperture are added to upper outer surface of the upper cone. Such structures having an aperture allow for attachment of a cord or other holding handle or even can be fashioned into a holding handle for portability. Additionally, such structures having an aperture may provide for anchoring or fastening of the water recovery system of the present invention to ground or even other floating devices. Such anchoring or fastening may be via cord (multiple devices encircling and lashed to a central device can serve to stabilize that central device and the peripheral devices while floating in a marine environment).

Adhesive waterproof tape, or other connecting means such as a grooved silicone O-ring with bacteria and algae preventing substances embedded are expediently provided for rapid assembly and holding together all molded parts.

In an alternative embodiment, grooved edges of the adjoining structures allow for rapid snapping together and thereby rapid assemblage of the device. Adhesive tape vs. silicone sealing rings vs snapping-together assemblage allow the end user more ability to tailor assemblage and cleaning and any repairs as per the milieu where the device is most frequently employed.

In some embodiments of the water recovery system of the present invention, the condensate leaving the device passes through a cartridge. In some cartridge containing embodiments, the post-exit cartridge filters out sand, dust, bacteria, etc., that may have encroached into the condensate. In other cartridge-containing embodiments, the cartridge adds electrolytes or other desired salts to the potable water.

In a still further embodiment of the water recovery system of the present invention, the upper cone may be enlarged by molded in zones and/or shaped raised sections, particularly in the form of grooves or corrugations, to enlarge the internal condensing surface of the upper cone and thereby achieve more optimal cooling. Such grooves also can allow for packing of snow into limited external portions of the device to facilitate cooling, for example, when the device is employed in an alpine setting and/or on a glacier.

The assembled water recovery system of the present invention provides for ease of, and intuitive handling. In preferred embodiments, the inferior most collecting channel provides a stabilizing structure for the entire device as its external portions contact the external milieu and it rests on those external portions when sitting on the ground or while floating. Additionally, the external portions of the collecting channel of embodiments provides, inferiorly, a grasping and/or holding edge with which the entire device can be picked up and/or held or moved or transported.

Alternatively, in a marine environment, the collecting channel also serves as a floating aid, with a simple design that allows the condensation process in a protected micro-environment inside the structure and protected from waves and disruption or contamination of the condensate. Notably, the device does not require any significant maintenance, can be stacked a) in whole or b) as component parts and is notably ready for use nearly immediately without any further complicated attachments or usage or any needed tools or other devices. In short, it is very user-friendly. Due to the envisioned molded shapes, these molded shapes can also be safely and efficiently stacked without much ado while the stacks so formed themselves are nesting and are very easy to transport given minimal weight and bulk. Alternatively, the devices can be assembled and lashed together, for example with cord or rod passing through the aligned central apertures in top and bottom cones, side wall and closing feature (i.e, along the central vertical axis of the device) for retaining a stacked, pre-assembled conformation, notably if transported with no time or feasibility or desire for assemblage at the end destination or if rapid deployment in numbers of the device is desired.

### BRIEF DESCRIPTION OF THE DRAWINGS

FIG. 1 is a transparent side view of an inner cone of conical embodiment of the water recovery system of the present invention.

FIG. 2 is a transparent side view of a side wall of a conical embodiment of the water recovery system of the present invention.

FIG. 3 is a transparent side view of an upper cone of a conical embodiment of the water recovery system of the present invention.

FIG. 3A is a side view of a closing feature for an upper cone of a conical embodiment of the water recovery system of the present invention.

FIG. 4 is a transparent side view of an assembled simple embodiment of the water recovery system of the present invention.

FIG. 5 is a top view of an upper cone of a conical embodiment of the water recovery system of the present invention.

FIG. 6 is a transparent side view of an assembled conical embodiment of the water recovery system of the present invention positioned over a source plate.

FIG. 7 is side view of an assembled conical embodiment of the water recovery system of the present invention showing the path of vapor resulting in condensation positioned over a source plate.

FIG. 8 is a transparent side view of an assembled conical embodiment of the water recovery system of the present invention having a second side wall.

FIG. 9 is a transparent side view of an assembled conical embodiment of the water recovery system of the present invention having a second and third inner cone as well as a second and third side wall and a closing feature.

FIG. 10 is a transparent side view of an assembled conical embodiment of the water recovery system of the present invention with a conventional sealing cap removed.

FIG. 11 is a transparent side view of an assembled conical embodiment of the water recovery system of the present invention with a Fresnel lens attached to top of the upper cone.

FIG. 12 is a transparent side view of an assembled conical embodiment of the water recovery system of the present invention with a closing feature; the water recovery system has a plurality of legs projecting down from the bottom of the assembled system to position the assembled system above an enlarged source plate.

FIG. 13 is a transparent side view of an assembled conical embodiment of the water recovery system of the present invention with a closing feature having pores in the upper cone.

FIG. 14 is a transparent side view of an assembled conical embodiment of the water recovery system of the present invention having a second inner cone as well as a second side wall and a closing feature.

FIG. 15 is a transparent side view of an assembled conical embodiment of the water recovery system of the present invention having a second and third inner cone as well as a second and third side wall and a closing feature.

FIG. 16 is a cross-sectional view of an assembled conical embodiment of the water recovery system of the present invention having a second and third inner cone as well as a second and third side wall and a closing feature shown along axis A-A in FIG. 5.

FIG. 17 is a transparent exploded view of an inner cone of an embodiment of the water recovery system of the present invention in which the inner cone comprises 4 component pieces.

FIG. 18 is a transparent exploded view of a side wall of an embodiment of the water recovery system of the present invention in which the side wall comprises 4 component pieces.

FIG. 19 is a transparent exploded view of an upper cone of an embodiment of the water recovery system of the present invention in which the upper cone comprises 4 component pieces.

FIG. 20 shows an assembled embodiment of water recovery system in which the four component parts each of the inner cone, side wall, and upper cone are assembled with closing feature attached.

FIG. 21 shows a disassembled and stacked embodiment of water recovery system in which the four component parts each of the inner cone, side wall, upper cone and closing feature are disassembled to a protective storage container for storage or transport.

FIG. 22 shows the side wall of an embodiment of the water recovery system of the present invention in which removable fins are placed internally to increase the condensing surface area of the side wall.

FIG. 23 shows a top view of an embodiment in which seven assembled water recovery systems of the present invention are connected to form a structure for use in a marine environment.

FIG. 24 is side view of an assembled conical embodiment of the water recovery system of the present invention positioned over a deep contaminant-water source plate or barrel.

FIG. 25 is side view of an assembled conical embodiment of the water recovery system of the present invention showing ingress of contaminated source-water into the collecting channel.

FIG. 26 shows a side view of an embodiment of the present invention in which the upper aperture of the inner cone has a downwardly projecting wall.

FIG. 27 shows a side view of an embodiment of the present invention in which an upwardly projecting wall arises from the central aperture of the inner cone as well as a downwardly projecting wall from the inner cone and a downwardly projecting wall from the upwardly projecting wall.

FIG. 28 shows an embodiment of a tongue-in groove locking mechanism to connect the pieces of the water recovery system of the present invention.

FIG. 29 shows an exploded view of a water recovery system with an embodiment of a silicon ring mechanism to connect the pieces of a water recovery system of the present invention.

FIG. 30 shows an assembled embodiment of a water recovery system of the present invention using a silicon ring mechanism to connect the pieces of the system.

### DETAILED DESCRIPTION OF THE INVENTION

Embodiments of the present invention recover safe drinking-water from aqueous compositions that may not be potable. Desirably, embodiments of the present invention have an outer diameter of between about 1 ft. (0.30 m) to about 10 ft. (3.0 m). It is further preferred that the outer diameter of embodiments of the present invention are between about 1.5 ft. (0.45 m) and about 6 ft. (1.8 m).

Embodiments of the present invention, in their assembled form, typically have an inner cone and a side wall forming a water collection channel, as well as an upper cone. In alternative embodiments of the present invention, the device may be disassembled. In further preferred embodiments, the inner cone, side wall and upper cone each constitute a plurality of subparts that can be disassembled. In still further preferred embodiments of the present invention, each inner cone, side wall and upper cone part of the device constitute a plurality of substantially identical subparts. For instance, the side wall can be manufactured in halves or quarters to allow nesting of these parts, and two halves or four quarters, etc, can then be snapped, clipped or secured together by external fasteners or tapes (multiple options).

The present invention provides a device for recovering of drinking-water as a condensate from contaminated source water. Embodiments of this device can include a conical, pyramidal or dome-shaped upper cone 300 made of a transparent synthetic resin such as PET, PE, PP or PC or other, which is resistant to damage from ultraviolet (UV) radiation but is substantially transparent to UV radiation. Upper cone 300 can have a conical, pyramidal or dome shape. A superior section of upper cone 300 has an open top area (i.e., a cone with an aperture, preferably an aperture at its apex). Generally, the inferior horizontal plane of upper cone 300 is open (i.e, a cone with no bottom).

A preferred embodiment of the present invention comprises both an inner cone and an upper cone. It is further preferred that the inner cone and the upper cone are substantially identical. It is still further preferred that the embodiment of the present invention has a side wall between and connecting the inner cone and the upper cone. It is further preferred that the height of the side wall is variable allowing for optimization as per milieu.

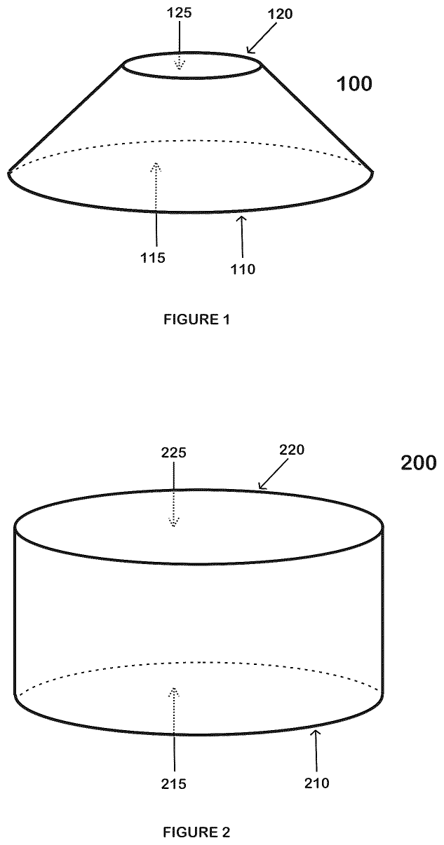

Turning to FIG. 1, this Fig. shows a conical embodiment of inner cone 100. Inner cone 100 has a bottom edge 110 and a superior edge 120. Bottom edge 110 defines an aperture 115. Superior edge 120 defines an aperture 125. Aperture 115 and aperture 125 are in communication.

FIG. 2 shows a cylindrical side wall 200. Cylindrical side wall 200 has a bottom edge 210 and a superior edge 220. Bottom edge 210 of side wall 200 defines an aperture 215. Superior edge 220 of side wall 200 defines an aperture 225. Aperture 215 and aperture 225 are in communication.

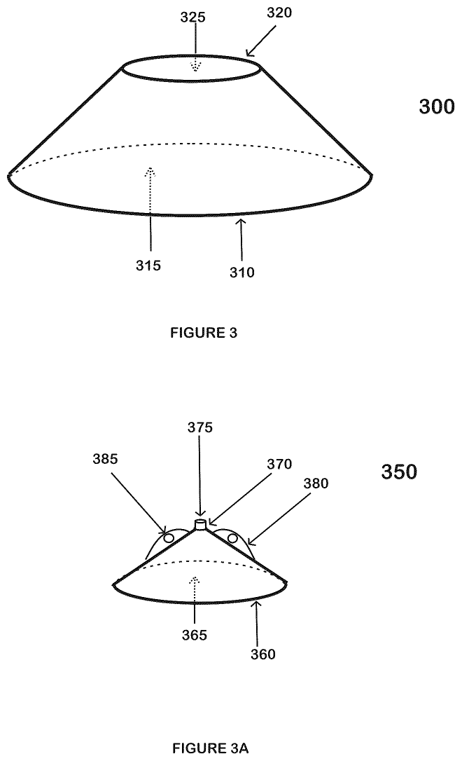

FIG. 3 shows an embodiment of upper cone 300. Upper cone 300 has a bottom edge 310 and a superior edge 320. Bottom edge 310 defines an aperture 315. Superior edge 320 defines an aperture 325. Aperture 315 and aperture 325 are in communication.

FIG. 3A shows an embodiment of closing feature 350 for use in sealing a device of the present invention. Closing feature 350 has a bottom edge 360, which is adapted to be secured to superior edge 320 of upper cone 300. Additionally, closing feature 350 has a cylindrical tube 370 positioned at the apex of closing feature 350. Bottom edge 360 of closing feature 350 defines an aperture 365. Cylindrical tube 370 has a hollow center 375 that is in communication with aperture 365.

In some embodiments, there are one or more projections 380 on the exterior surface of closing feature 350. Projections 380 may have an aperture 385. Apertures 385 may be used to secure the water recovery system of the present invention to the ground or another structure. For instance, a cord or wire (not shown) may be threaded through one or more apertures 385 to secure the water recovery system of the present invention to the ground or another structure. In some embodiments, such projections 380 or with an aperture 385 can be found additionally or instead on the lower side wall 200 (not shown).

In some embodiments, cylindrical tube 370 may have exterior threads that mate with interior threads on a cap (not shown) that serves to close aperture 375. It is preferred that this cap is a conventional water bottle cap.

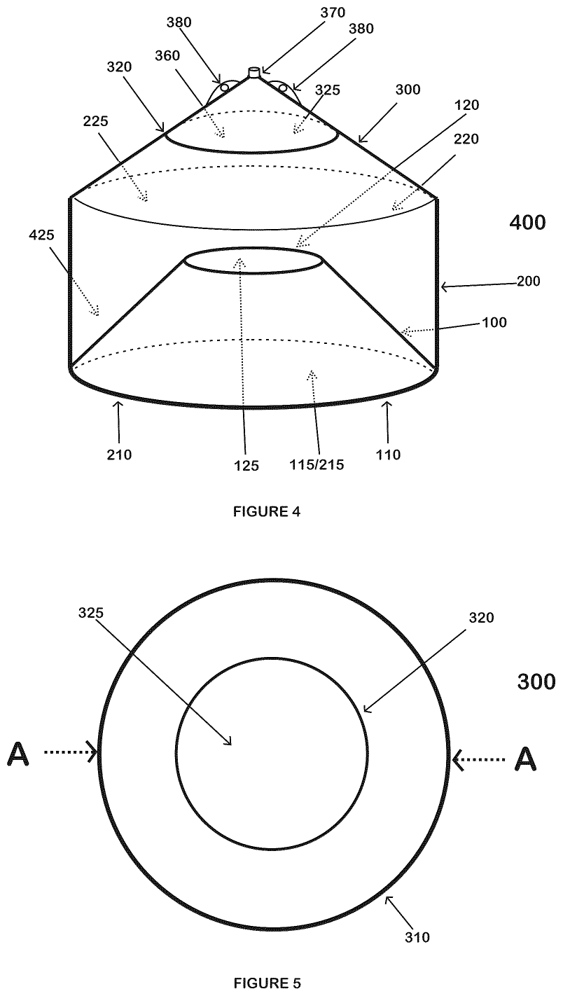

FIG. 4 shows a simple embodiment of the water recovery system 400 of the present invention. This embodiment has four components: inner cone 100; side wall 200; upper cone 300; and closing feature 350.

As can be seen in FIG. 4, in a preferred embodiment, the outer diameter—bottom edge 110—of inner cone 100 is substantially the same as the inner diameter—bottom edge 210—of side wall 200. As a result, when inner cone 100 is inserted into side wall 200, the friction between the exterior edge of the inner cone 100 and the interior of side wall 200 form a watertight seal and thus form a collecting channel 425.

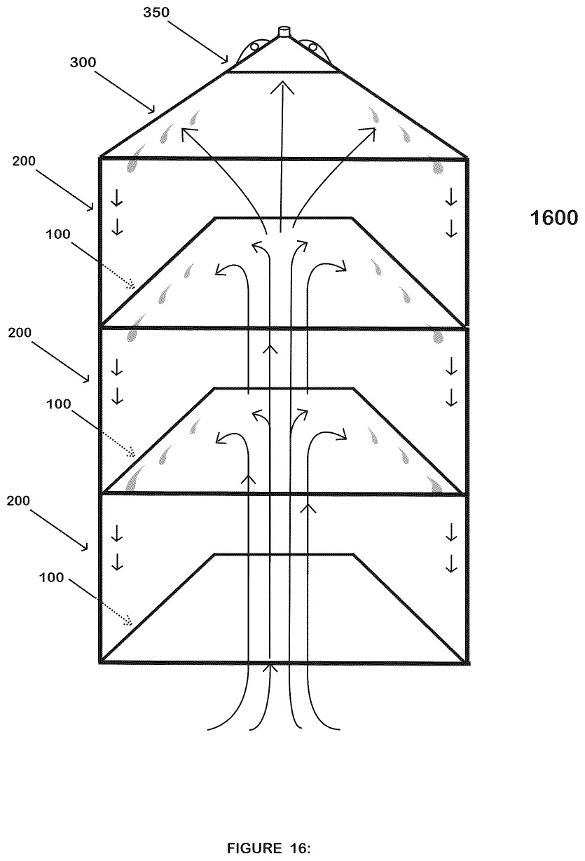

FIG. 5 shows a top view of upper cone 300. Bottom edge 310 of upper cone 300 is the outer circle and superior edge 320 of upper cone 300 is the inner circle forming aperture 325. FIG. 5 also shows line axis A-A along which the cross-sectional view of FIG. 16 is taken.

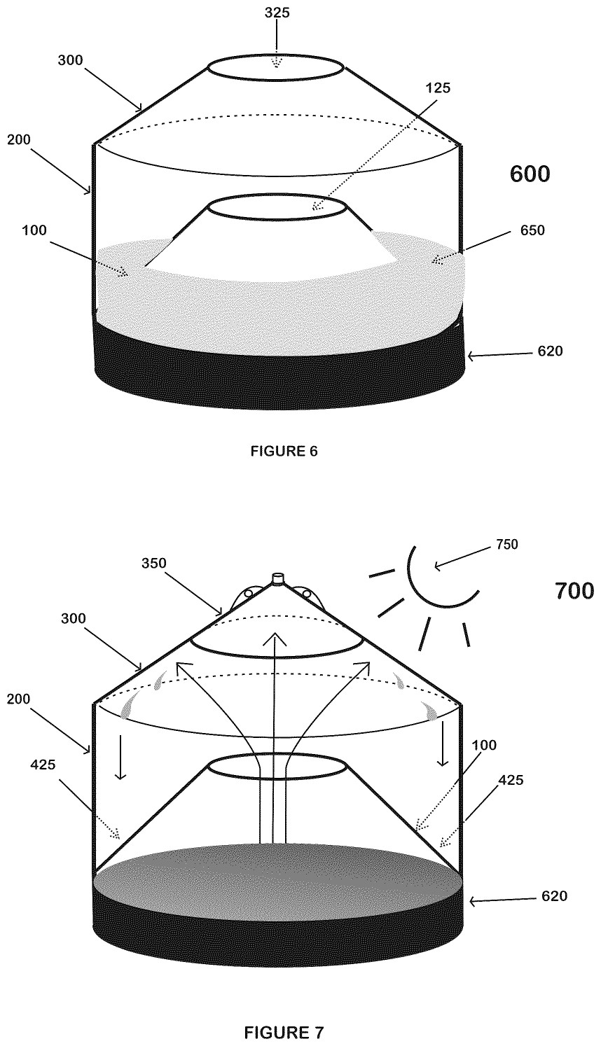

FIG. 6 shows an embodiment of an assembled water recovery system 600 of the present invention positioned on top of source plate 620. Desirably, source plate 620 is of a color that will absorb radiation and of a material that will allow the heat generated by an absorbed radiation to be released as heat to the water in the source plate. Black is a preferred color for source plate 620. In the embodiment of FIG. 6, the device has inner cone 100, side wall 200 and upper cone 300. Also shown in this Fig. are apertures 125 and 325. Additionally, shaded in gray is recovered purified water 650.

FIG. 7 shows the embodiment of FIG. 6 illustrating a source of radiant energy (sun 750) that evaporates some of the water in source plate 620. The water vapor rising from source plate 620 through aperture 125 and contacting the cooler interior surface of upper cone 300 and interior surface of side wall 200 then condenses as liquid water and is collected in the water recovery channel 425 formed by the inner cone and the side wall.

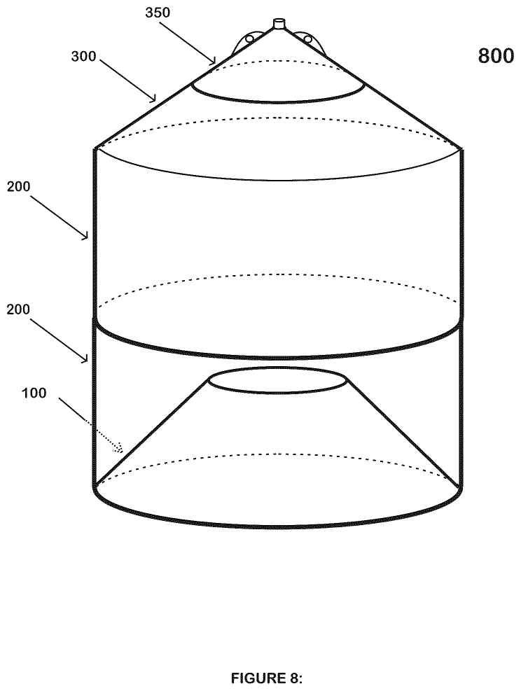

FIG. 8 shows yet another alternative embodiment of the water recovery system of the present invention 800. In this embodiment, the water recovery system has second side wall 200 mounted on first side wall 200. As a result, the water recovery system of this embodiment has a greater surface area for condensing the water vapor obtained by evaporating water from the source plate (not shown in this figure).

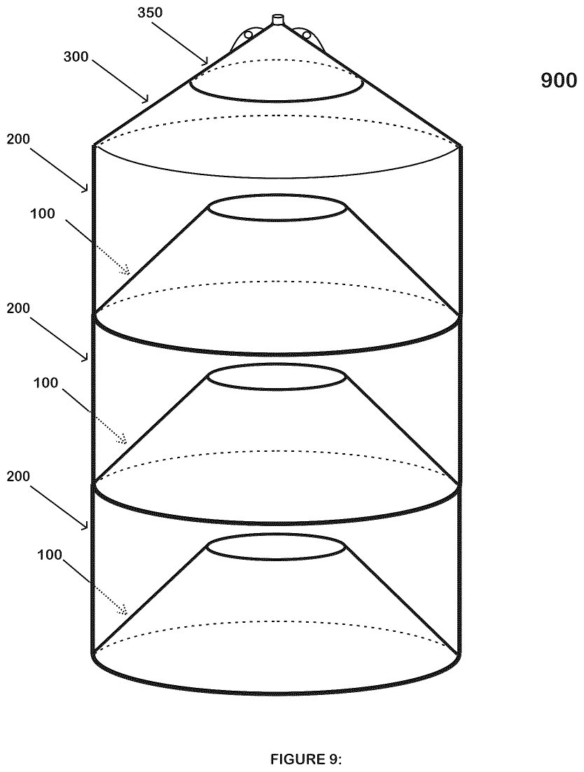

FIG. 9 shows a still further alternative embodiment of the water recovery system of the present invention 900. In this embodiment, the water recovery system has three inner cones, three side walls, an upper cone and a closing feature. As a result, the water recovery system of this embodiment has even greater surface area for condensing the water vapor obtained by evaporating water from the source plate (not shown in this figure).

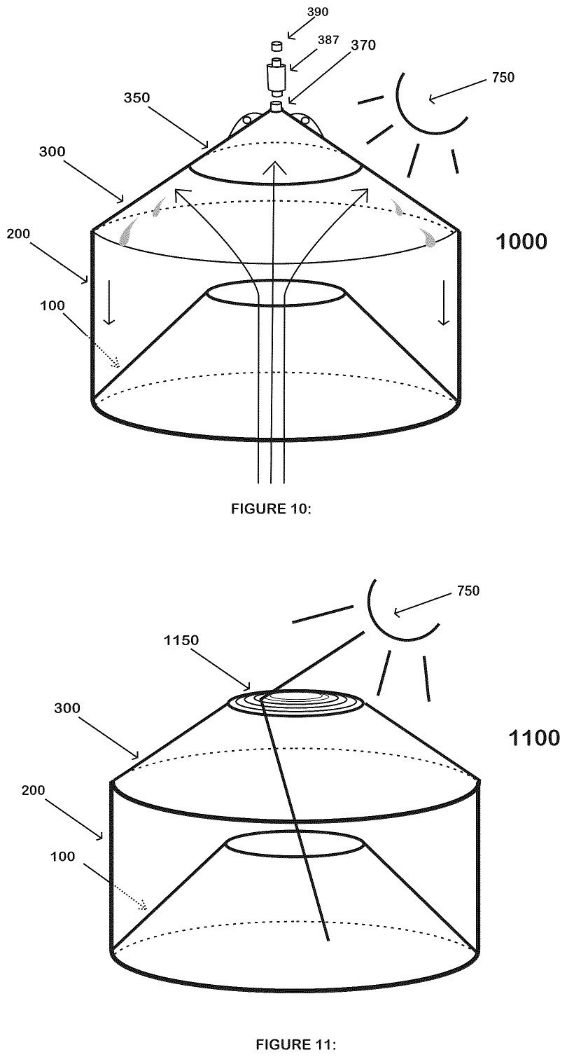

FIG. 10 shows yet another embodiment of the water recovery system of the present invention 1000. This embodiment has inner cone 100, side wall 200, upper cone 300, closing feature 350 with a cylindrical tube 370, as well as removable cap 390 shown removed from cylindrical tube 370. Also shown in FIG. 10 is source of radiant energy for evaporating water 750. FIG. 10 also shows cartridge 387 which can be used to add electrolytes to the recovered water, or to filter particulate matter such as sand, dust, bacteria, or viruses from the recovered water.

FIG. 11 shows a still further embodiment of water recovery system 1100 of the present invention. This embodiment includes inner cone 100, side wall 200, and upper cone 300. Additionally, in this embodiment, Fresnel Lens 1150 is placed in aperture 325 of upper cone 300 to focus the radiant energy hitting the system on the water in the source plate (not shown) below the device to increase the rate at which the water is evaporated from the source plate. Desirably, the outer diameter of Fresnel Lens 1150 is no greater than the outer diameter of aperture 325.

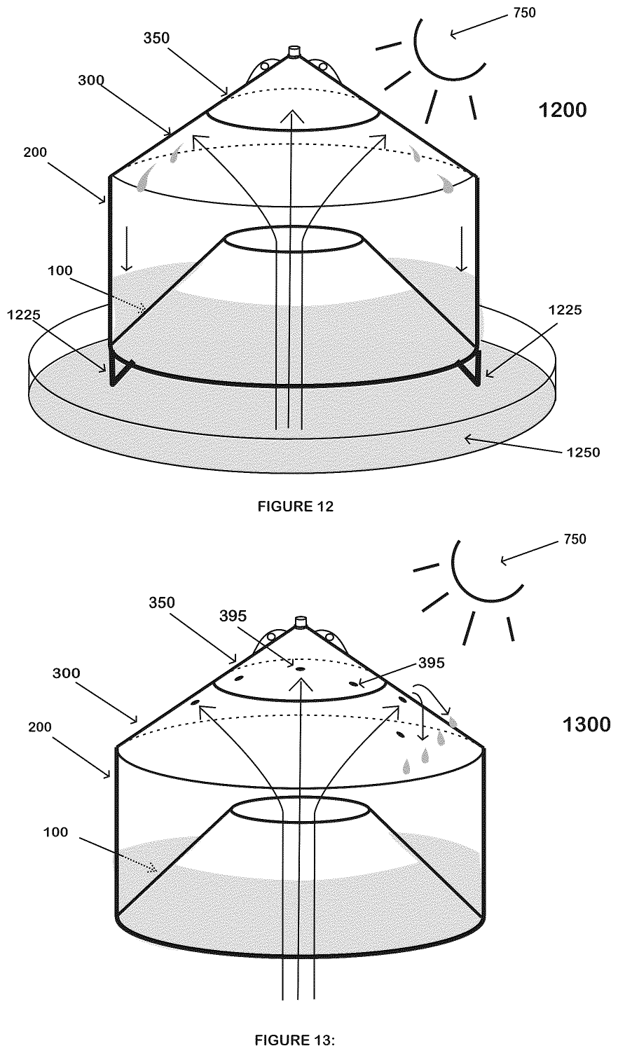

FIG. 12 shows yet another embodiment of water recovery system 1200 of the present invention. Again, the embodiment includes inner cone 100, side wall 200, upper cone 300, and closing feature 350. In this embodiment, source plate 1250 (for holding the non-potable water) has a diameter greater than that of water recovery system 1200. Additionally, water recovery system 1200 has a plurality of legs 1225 that raise the bottom of water recovery system 1200 above the water in source plate 1250.

FIG. 13 shows a still further embodiment of water recovery system 1300 of the present invention. Again, the embodiment includes inner cone 100, side wall 200, upper cone 300, and closing feature 350. Additionally, it is believed that the plurality of pores 395 in upper cone 300 enhances the temperature gradient between source plate 1250 and the water recovery system 400.

In a preferred embodiment of the present invention, it is preferred that the sum of the surface area of all the pores in the upper cone is less than 1 cm².

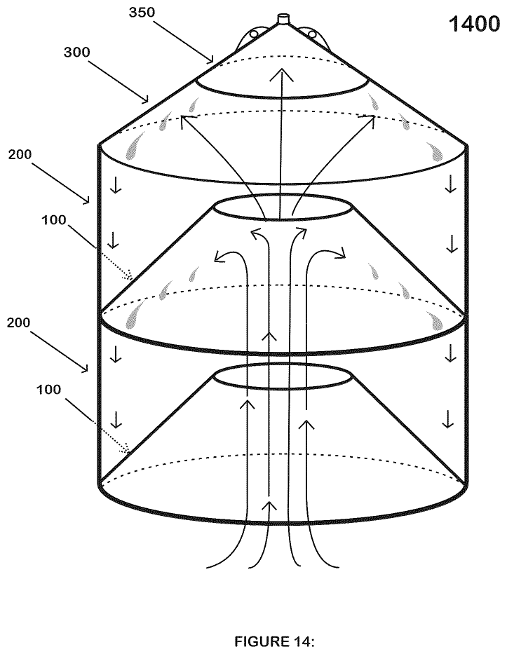

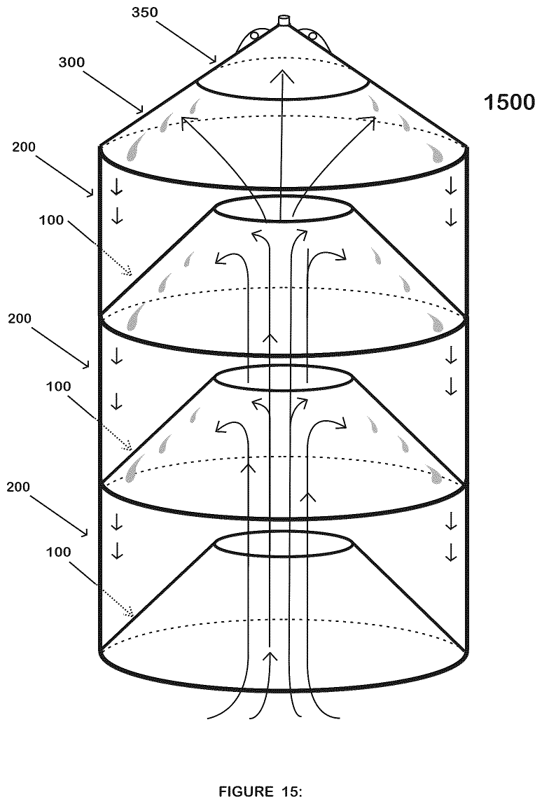

FIG. 14 shows the operation of water recovery system 1400 of the present invention. This embodiment includes two inner cones 100, two side walls 200, upper cone 300 and closing feature 350. The path of water vapor is shown with arrows, as is the path of condensate droplets. However, a source plate is not shown.

FIG. 15 shows the operation of water recovery system 1500 of the present invention. This embodiment includes three inner cones 100, three side walls 200, an upper cone 300 and a closing feature 350. However, a source plate is not shown.

FIG. 16 shows a cross-sectional operational view of embodiment 1600 that includes three inner cones 100, three side walls 200, an upper cone 300 and a closing feature 350. Again, the source plate is not shown.

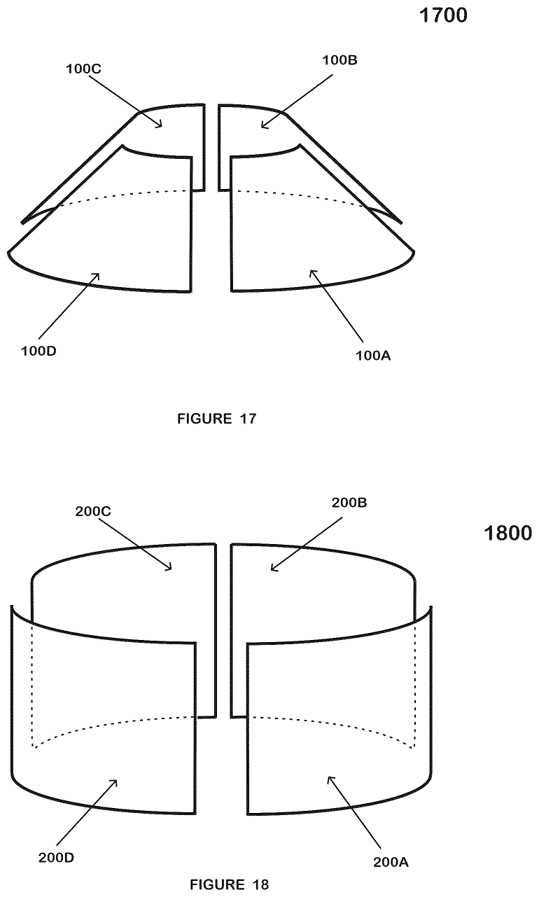

FIG. 17 shows an inner cone divided into four substantially identical subparts 100A, 100B, 100C, and 100D.

FIG. 18 shows a side wall divided into four substantially identical subparts 200A, 200B, 200C, and 200D.

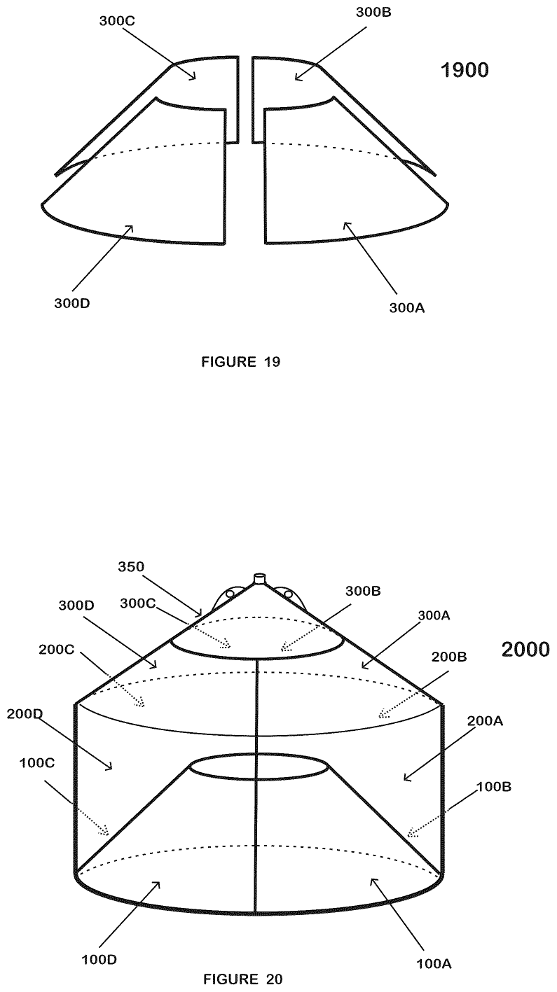

FIG. 19 shows an upper cone divided into four substantially identical subparts 300A, 300B, 300C, and 300D. FIG. 20 shows an assembled embodiment of water recovery system 2000 in which inner cone 100 is assembled from four identical subparts, side wall 200 is assembled from four identical subparts, upper cone 300 is assembled from four identical subparts, and closing feature 350 can attach to upper edge 320 via threads and closing feature 350 helps secure the identical 300A-D subparts in place. In this embodiment, adjacent parts are held together by a detachable waterproof tape applied externally to the device (not shown in figure).

FIG. 21 shows a disassembled embodiment of water recovery system in which the four component parts each of the inner cone 100A-D, side wall 200A-D, and upper cone 300A-D are disassembled with the closing feature 350 placed to a storage box (not shown) for protection, storage or transport. In one embodiment of such a storage container in box form, the box can be snapped together or secured with tape or waterproof tape, and alternatively itself disassembled into component pieces (not shown). The sealed box itself can be used as a purified water storage container or alternatively as a container for collecting and decanting contaminated water which can be decanted into the source tray 620. FIG. 21 also shows cartridge 387 that in some embodiments is attached to aperture 370 of closing feature 350 to add electrolytes to the potable water.

In an embodiment of a storage container in FIG. 21, a storage tube 2150 can be used. The closing feature 350 of the water recovery device can be used to close such tube 2150, even with threading, repurposing such closing feature 350 of the water recovery system with dual use and thereby saving manufacturing and material and costs. Similarly, the storage tube or cylinder itself can be used as a purified water storage container or alternatively as a container for collecting and decanting contaminated water which can be decanted into the source tray 620.

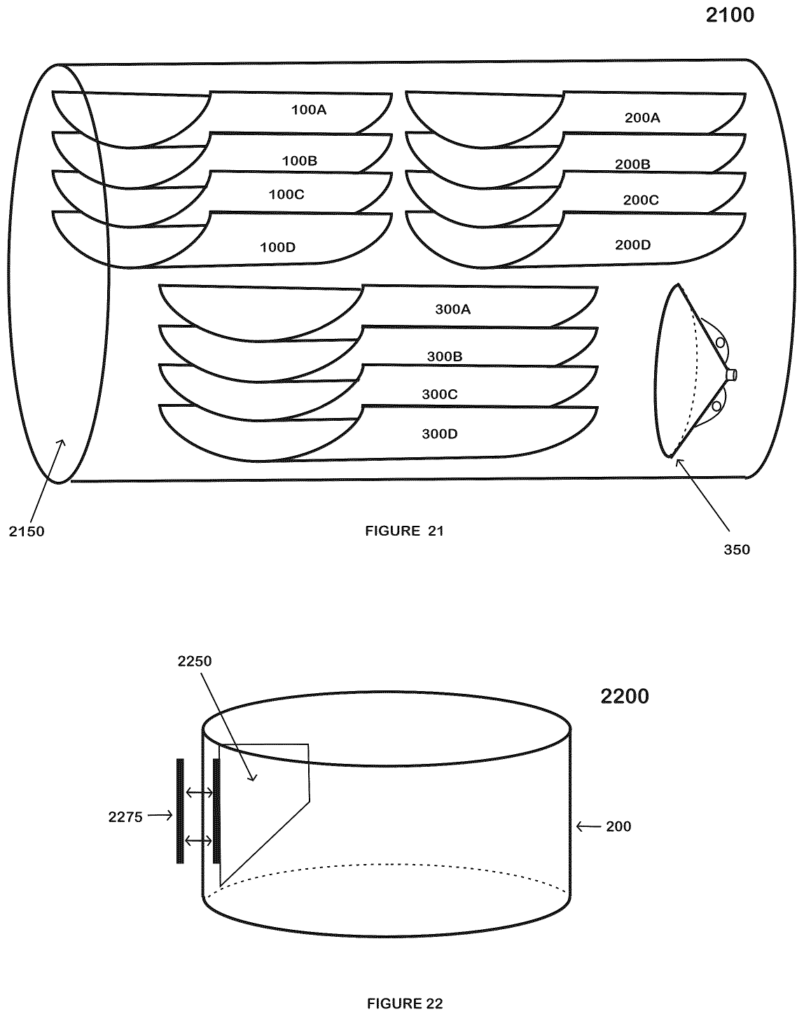

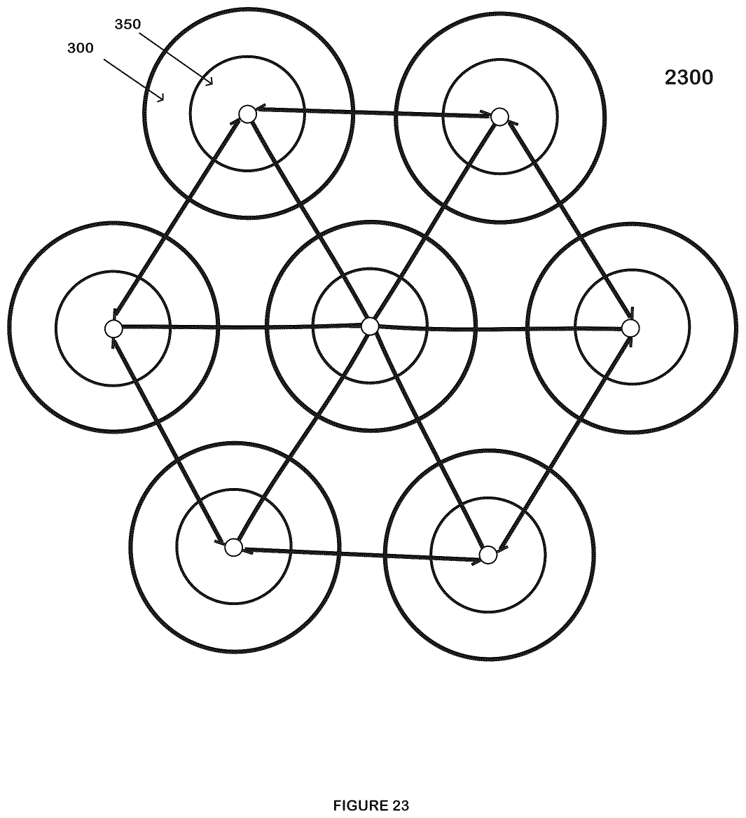

FIG. 22 shows the side wall 200 of an embodiment of the water recovery system of the present invention in which removable magnetic fin 2250 are placed internally via capture by magnet 2275 to increase the condensing surface area of the side wall or upper cone. Alternatively, the fin itself can be manufactured from metal and/or covered in Teflon or other plastic material and allow capture by a magnet external to the water recovery system. In either embodiment, the fin can then be moved or adjusted with movement of the external capturing magnet, and this allows a squeegee like affect to remove condensate from the inner surface of side wall 200, resetting the device for additional capture of condensate.

FIG. 23 shows a top view of the water recovery system in a marine milieu. In such a milieu, notably an additional device or better an adjacent “ring” of devices can be used to stabilize the centrally positioned device when lashed to it, as shown. Alternatively, such as when used in a marine environment and only one water recovery device is available or employed, a floating body or buoyancy ring or even marine safety floatation device(s) or additional circumferentially placed cord(s) can be lashed to the device to stabilize the device as deemed necessary per milieu (not shown).

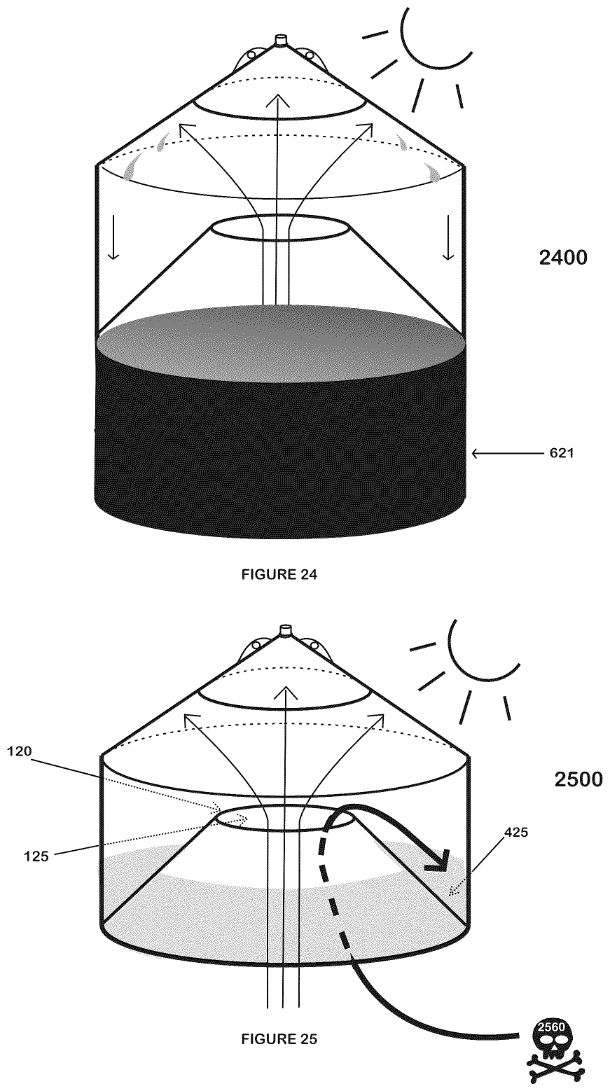

FIG. 24 is side view of an assembled conical embodiment of the water recovery system of the present invention showing the path of condensation positioned over a deep contaminant-water source plate or barrel or similar collecting device which can allow the device to be left unattended for an extended period, e.g., on a rooftop.

In an embodiment of the water recovery system of the present invention in which a side wall has a port, preferably a port located near the bottom of a side wall, a screw-in exit valve, with or without hose or tubing to flow to a larger collection vessel, may be inserted into the port (not shown). It is further desired that when the device is left unattended for days a hose connects the exit port to a collecting vessel or task (e.g., irrigation, water for livestock, etc.). (not shown). Such an arrangement might be useful when the device is on a roof top or in a remote setting. In such a use, the user collects the potable water on their return. Such an arrangement may be useful in a developing country where transportation to distant water sources remains an issue or is costly. Additionally, the condensation process can continue uninterrupted over longer time intervals with condensate removed from collecting channel via such an exit valve directed to a sanitary collecting vessel or other task.

FIG. 25 is a side view of an assembled conical embodiment of the water recovery system of the present invention showing the accumulation of purified water in the collecting channel (shaded in gray). In a marine milieu, undesired contaminant source water 2560 (call number emphasized as hazard by skull and cross bones) that enters the water recovery system is a potential hazard: wave force or other force(s) pushes source water up and into the device through aperture 125 (and over edge 120) then via gravity it flows down into the collecting channel 425 thereby contaminating any purified water or future purified water in the collecting channel 425. Contaminant source water entering the device, then, can cause a multiplicity of undesired safety and health concerns.

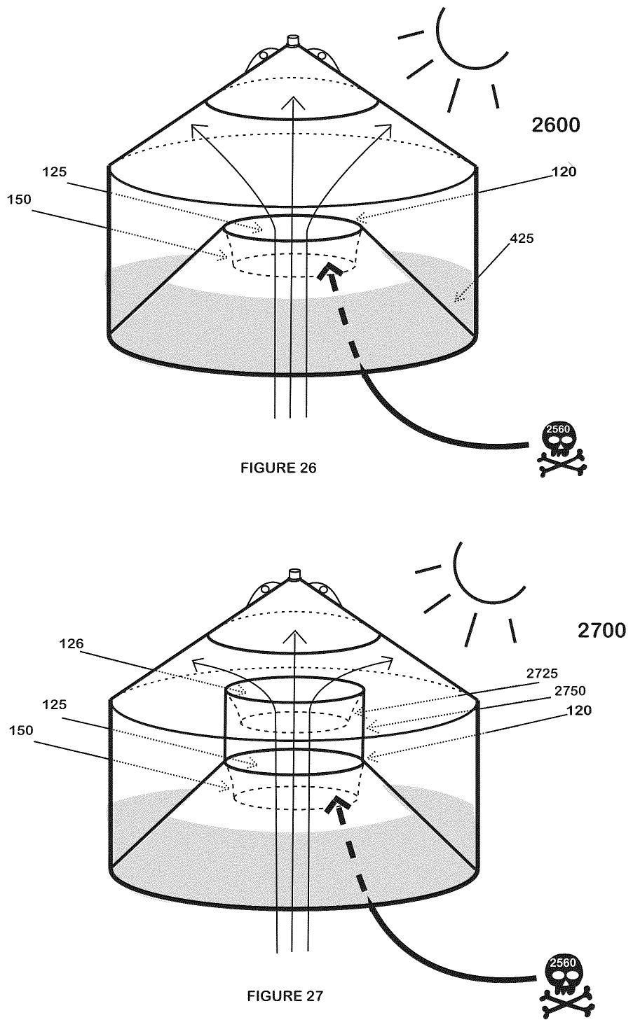

FIG. 26 is side view of an assembled conical embodiment of the water recovery system of the present invention showing the inner (medial) edge 120 of aperture 125 of the inner collecting wall molded downwards 150 to protect from, and prevent wave forces, that force entrance of contaminated water upwards and into the water recovery system including the collecting channel.

In one such embodiment of the water recovery system, the inner cone features such a downwards flanged edge 150 as a detachable and/or screw-in ring-shaped piece (not shown).

FIG. 27 shows a further embodiment of this device, an adaptation to the inner cone to protect purity of condensate in the collecting channel. The uppermost edge 120 of the inner collecting wall can be projected upwards further into the space of the water recovery system by a cylindrical snorkel-like detachable tube 2750 having an inner diameter equal in diameter to the upper aperture 125 of the lower cone and an upper aperture 126.

In a further preferred embodiment of this variant, the exterior of this short cylindrical upward projection has threads for ease of connectivity to edge 120 of the inner cone. A cylindrical tube having a matching thread on its exterior base can be rapidly deployed via matching threads on the lower cone edge 120 and now aperture 125 becomes continuous with aperture 126 at the top of this cylindrical upward projection. becoming a more effective barrier to contaminant water 2560 ingress into the water recovery system. FIGS. 26 and 27 show the boldened arrow of contaminant water ingress 2560 stopping at the phlanged edges 150 and 2725, and hence not entering or considerably less likely to enter the collecting channel 425.

In cases of deployment of the water recovery device over appreciable periods of time and/or appreciable condensate yields over time, this added cylindrical protective structure 2750 added to the top of the inner collecting wall edge 120 also protects against partial submersion of the device when employed in a hostile marine environment and/or when disruptive movements of the device are envisioned (e.g., waves or wind-storms or boat movements) or lifting the device out of the source water).

A further preferred embodiment of this upward projecting and protecting cylindrical tube is that it can contain a downwards flanged edge 2725 even as a detachable and/or screw-in ring-shaped piece at the top of this added protective structure 2750 (not shown, but like further embodiment of FIG. 26). In still further preferred embodiments, notably when additional side walls and inner cones are employed, additional protecting cylindrical tubes prophlactically “stacked” inside the device (via threads) for greater barrier effect (not shown in FIG. 27).

A further preferred embodiment of this upward projecting and protecting cylindrical tube is that it can contain variant one-way protective floating ball-in-valve or other type flat horizontally situated movable ring structures (not shown) in the lumen of the cylindrical tube 2750 that prevent waves of contaminated water from intruding into the device while the device is floating (i.e., progressively stricturing, movable (by water forces) and horizontally situated rings in the lumen between apertures 125 and 126 when such rings float upwards in the lumen of cylindrical tube 2750), they narrow or close off the lumen), yet otherwise allowing for constant passage of water vapor upwards into the device when they are not activated, i.e., when waves are not surging upwards into the device.

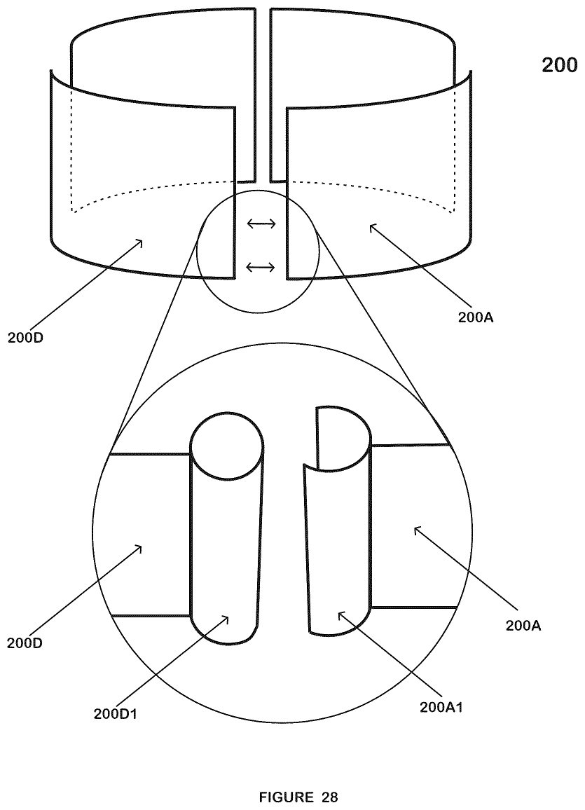

FIG. 28 shows a disassembled and zoom-in view of the side wall 200 in an embodiment of water recovery system utilizing tongue-in-groove or male-female type locking mechanism of the quadrant parts of the side wall to close and seal the quadrants of the side wall (similar mechanism of interlocking closure utilizable on inner cone and upper cone—not shown in this figure). For example, side wall 200 is assembled from four substantially identical side wall pieces In a preferred embodiment, each pair of the abutting substantially identical side wall pieces (200D and 200A, for example) locks together along a vertical axis with a tongue-in-groove type configuration (e.g., 200D1 connects with 200A1, and so on, as seen in magnified inset in FIG. 28).

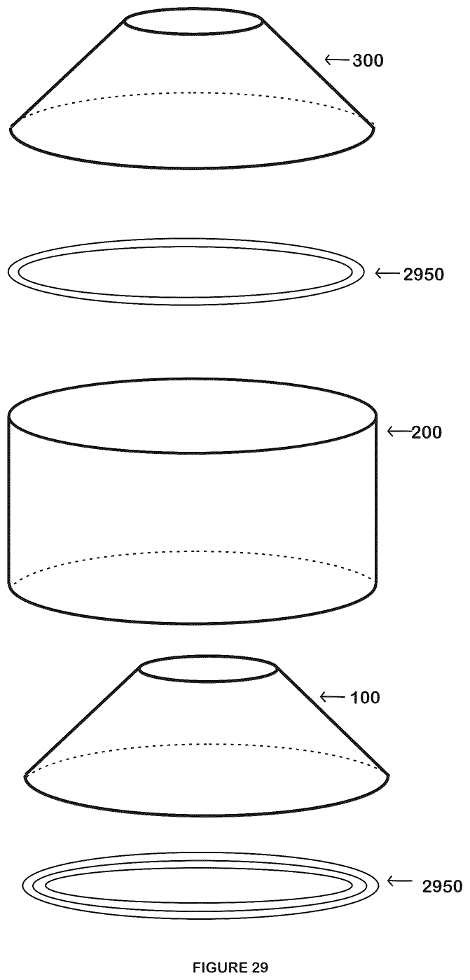

An alternative embodiment of the water recovery system of the present invention is shown in FIG. 29, in which the bottom edge 110 of inner cone 100 is connected to the bottom edge 210 of side wall 200 by a seal 2950. For instance, the bottom edge 110 of inner cone 100 and of bottom edge 210 of side wall 200 are inserted into a groove in a silicone or rubber sealing ring 2950 wherein the diameter of ring 2950 is substantially the same as the diameter of both the inner cone 100 and the side wall 200. When connected, ring 2950, inner cone 100, and side wall 200 form a watertight seal. Thus, in this embodiment, the collecting channel is formed, and importantly its integrity is protected by inner cone 100, silicon rubber ring 2950 and side wall 200.

In a further embodiment of the water recovery system of the present invention, the outer diameter of inner cone 100 is narrower than the inner diameter of side wall 200. In this embodiment, the inferior edge 110 of inner cone 100 is attached to the inferior edge 210 of side wall 200 by separate flooring wherein such floor or flooring is the bottom surface of the collecting channel to form a watertight collection channel (not shown). It should be noted that wider floor concomitantly increases the surface area of the upper-most surface of water in the collecting channel, and this variable can be tailored to the milieu, if needed or desired.

In a variant of this embodiment with a floor connecting side wall 200 to inner cone 100, the combination of side wall 200, inner cone 100, and the connecting floor are molded as a single piece (not shown).

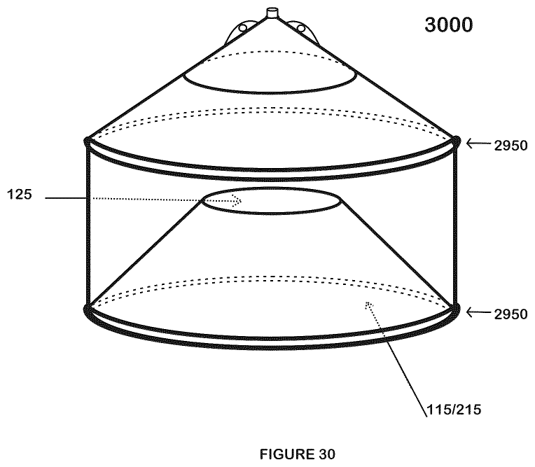

FIG. 30 shows a water recovery system of the present invention assembled from inner cone 100, side wall 200 and upper cone 300, each with a plurality of parts. The inner cone, for example, is formed by assembling four substantially identical inner cone pieces 100A-D into a single inner cone 100 with the silicone or rubber seal 2950 holding and stabilizing abutting inner cone pieces in place inferiorly along bottom edge of the inner cone 110. Similarly, silicone or rubber seal 2950 holds and stabilizes abutting side wall 200 and upper cone 300 component pieces 200A-D and 300A-D when this seal 2950 is placed on side wall upper edge 220 and upper cone inferior edge 310. (shown in Figure, as compared to FIG. 28 200A1 and 200D1).

In a variant of the embodiment in FIG. 30 between each pair of the abutting substantially identical inner cone pieces 100A-D, side wall pieces 200A-D, and upper cone pieces 300A-D is a piece of silicon or rubber with a groove on each side (not shown in figure) rather than a tongue-in-groove structure as in 28A1 and 28D1.

Upper cone 300 similarly can be assembled from four substantially identical upper cone pieces (as in FIG. 20). The abutting upper cone pieces are also connected by a piece of silicon rubber with a groove on each side to form the upper cone (not shown).

In one embodiment of the present invention, a plurality of side walls of different heights are provided. For instance, a kit from which an embodiment of the present invention might be assembled could contain side wall components 200 A-D that can be assembled into a side wall having a height of: h, 1.5 h, 2 h, and 3 h.

In a further embodiment of the water recovery system of the present invention is a kit. Said kit may comprise a collection of the pieces necessary to assemble a functional water recovery system. In another embodiment of a kit embodiment the kit may include a means for strengthening the connections of said kit when assembled, for instance a waterproof adhesive tape. In yet a further embodiment of the recovery system of the present invention, the kit may include a magnetic fin and an anchoring magnet. Additionally, a water recovery system kit according to the present invention may include a source water tray. In a still further embodiment of the water recovery system kit of the present invention, the kit might include an electrolyte cartridge that adds electrolytes to the water as it is poured through the cartridge.

Each of the cones on the present invention can be manufactured as component pieces, i.e., quartered, thirds or halved on an axis perpendicular to the circumference of the cones. Making embodiments of the present invention from component parts reduces the volume of the device improving the ability to transport or store or carry the device of the present invention. Specifically, in an embodiment comprising symmetric quartered parts, the quartered parts can be conveniently “nested.” For example, 10 cones where both the inner and upper cone parts are “quartered” (4 “quartered” parts per cone, i.e., inner and upper cones each rendered as 4 pieces) would result in 80 total “quartered” parts. These 80 “quartered” cone parts could readily be transported, shipped, or carried, a backpack, (i.e., stacked, for example, in two nesting columns of 40 parts each). Similar math would apply to the side wall (i.e., 40 additional sub-parts). These 120 “quartered” cone and wall parts, or by counterexample, stowed under the seat of a lifeboat or stowed in an overhead bin of an aircraft.

Additionally, the connecting side wall[s] section[s] can also be quartered with similar benefits—quartered side walls for 10 cones results in 40 additional parts. Using thirds or halves of both cones and side wall structures are alternative embodiments of the present invention.

If one or more parts of an embodiment of the present invention that can be disassembled are damaged or lost, the damaged or lost part can readily be replaced by an undamaged and/or new part.

In yet a further embodiment of the present invention, linear spacers can be added between the opposing quarter to enlarge the overall structure into an ellipsoid/oval form, or even square form with round edges.

It is believed that the component parts of embodiments of the present invention can be expediently molded and manufactured at a low price, which is particularly expedient for commercial and/or applications in developing counties or where transport or shipping costs are excessive.

In a still further embodiment of a decanting opening in its closing feature, the closing feature has a thread on its lower exterior that mates with a thread on the interior of the upper aperture of the upper cone. Thus, the closing feature can be screwed into place in the opening in the upper cone. It is desired that the apex of the closing feature has a short cylindrical tube projecting upwardly. It is further preferred that the exterior of this short cylindrical tube has a thread that mates with the conventional cap found on commercially available water bottles (should the lid become lost, i.e., very low or no-cost replacements).

In some embodiments of the present invention, the closing feature is replaced with a Fresnel-type lens structure. In such embodiments, the lens structure closes off the device to prevent the condensate from escaping. Additionally, the Fresnel-type lens amplifies the energy source striking the bottom tray of contaminant water. It is believed that this amplified energy accelerates the evaporation and condensing process and thereby increased condensate yield. Lens variants, anchorable via optional threads at edge 320, can implemented in variant embodiments of the present invention.

The conventional lid-housing structure allows closure but also decanting. Being appropriately, and superiorly placed, this opening cannot be easily soiled, nor can condensate flow out in an undesirable manner. Alternatively, the lens structure can be stored inside the bottom section to seal the bottom opening, thereby converting the cone structure into a water storage container.

Alternatively, reduplication of the collecting channel vertically in space can be accomplished by stacking the inner cone and side wall sections—these sections “paired” forming the minimum conformation in space to create a collecting channel. Hence, a bottom section-mid section pair stacked on top of such a pair, or repeatedly stacked in such a configuration allows for a collecting device with multiple collecting channels, enhancing yield of condensate and also requiring less frequent attention to the device to evacuate a full collecting channel. A top section can then close the device consisting of 1 to n stacked pairs, either with lens or lid, as mentioned above.

What I claimed is:

1. A water recovery system comprising:
A base portion, said base portion having an outer perimeter with a receiving member adapted to attach to a side portion, said base portion further having an interior that rises from the outer perimeter to an aperture near the center of said base portion;
Said side portion rising from the receiving member of said base portion substantially perpendicular to said base portion; and
A top portion having a second receiving member adapted to attach to said side portion at its outer perimeter, the perimeter of said top portion gradually decreasing to form an aperture near the center of said top portion.

2. The water recovery system according to claim 1 wherein said base portion comprises at least 2 pieces.

3. The water recovery system according to claim 1 wherein said side portion comprises at least 2 pieces.

4. The water recovery system according to claim 1 wherein said top portion comprises at least 2 pieces.

5. A water recovery system comprising:
A base portion, a side portion, and a top portion, said base portion joined to said side portion, and said side portion is joined to said top portion wherein the vertical height of said side portion is greater than the height of said top portion.

6. The water recovery system according to claim 5 wherein the vertical height of said side portion is at least twice the vertical height of said top portion.

7. The water recovery system according to claim 6 comprising a top portion having a plurality of perforations, each of said perforations having a surface area of no more than 1 cm².

8. A water recovery system comprising:
a. A side wall;
b. A first inner cone, said first inner cone mounted against the interior of said side wall near the bottom of said side wall; and
c. A second inner cone, said second inner cone mounted against the interior of said side wall near the upper top of said side wall.

9. A water recovery system kit comprising:
a. a plurality of side wall subparts sufficient to form a side wall;
b. a plurality of inner cone subparts sufficient to form an inner cone; and
c. a plurality of upper cone subparts sufficient to form an upper cone.

10. The water recovery system kit of claim 9 further comprising a means for strengthening the connections of said kit when assembled.

11. The water recovery system kit of claim 9 further comprising a magnetically attachable fin and an anchoring magnet.

12. The water recovery system kit of claim 9 further comprising a source water tray.

13. The water recovery system kit of claim 9 further comprising an electrolyte containing cartridge.
